(19) United States
(12) Patent Application Publication
(10) Pub. No.: US 2026/0349772 A1
(43) Pub. Date: Nov. 5, 2026

(54) METHOD AND SYSTEM OF IMPLEMENTING AN EVENT MESH NETWORK APPLICATION EMULATION TOOL

(71) Applicant: JPMorgan Chase Bank, N.A., New York, NY (US)

(72) Inventor: Bodhisatta SARKAR, Dublin, OH (US)

(73) Assignee: JPMorgan Chase Bank, N.A., New York, NY (US)

(21) Appl. No.: 19/653,892

(22) Filed: Apr. 21, 2026

Related U.S. Application Data
(60) Provisional application No. 63/800,028, filed on May 5, 2025.

(51) Int. Cl. G06F 9/455

(52) U.S. Cl. CPC G06F 9/45504

(57) ABSTRACT

A system is presented that implements an event mesh network application emulation tool. The system may be configured to: provide a GUI that comprises a first set of GUI-generated objects that comprises at least one GUI-generated object that correlates to at least one respectively corresponding event broker database of an event mesh network; based on a first set of interactions with the first set of GUI-generated objects, perform at least one from among a first set of push operations and a first set of pull operations on the at least one respectively corresponding event broker database; and modify the first set of GUI-generated objects to reflect results of the at least one from among the first set of push operations and the first set of pull operations. In the system, an LLM may be utilized to generate electronic transmission structures.

### CROSS-REFERENCE TO RELATED APPLICATIONS

This application claims priority benefit from U.S. Provisional Application No. 63/800,028, filed May. 5, 2025, the contents of which are incorporated herein in their entirety.

### BACKGROUND

### 1. Field

This disclosure generally relates to event mesh network applications and, more particularly, to a method, system and computer-readable medium for implementing an event mesh network application emulation tool.

### 2. Background

There is currently no technology available to provide for seamless and customizable browsing, and publishing, of event logs within an electronic communication network. Additionally, such browsing and publishing tasks generally require the performance of some form of coding. However, such requirements are neither user-friendly nor conducive to interoperability because under such requirements even simple tasks may require a complex coding effort that is time consuming to complete.

Such drawbacks limit software development in this environment. Therefore, there is a need in the field of the present disclosure, for a technological improvement that addresses these drawbacks and provides a technical solution to the absence of technology in the area of seamless and customizable browsing, and publishing, of event logs within an electronic communication network.

Accordingly, the approach disclosed herein is presented to improve the field of the present disclosure by addressing the above-mentioned problem that exists in today’s electronic communication networks.

### SUMMARY

The present disclosure, through one or more of its various aspects, embodiments, and/or specific features or sub-component, provides, inter alia, various systems, servers, devices, methods, media, programs and platforms for implementing an event mesh network application emulation tool.

According to an aspect of the invention, a method of implementing an event mesh network application emulation tool is provided. The method may comprise: providing a graphical user interface (GUI) that comprises a first set of GUI-generated objects that comprises at least one GUI-generated object that functionally and contextually correlates to at least one respectively corresponding event broker database of an event mesh network; based on a first set of interactions with the first set of GUI-generated objects, performing, on the at least one respectively corresponding event broker database, at least one from among a first set of push operations and a first set of pull operations; and modifying the first set of GUI-generated objects to reflect a result of the at least one from among the first set of push operations and the first set of pull operations. The at least one respectively corresponding event broker database may comprise a first partition.

In the method, the providing of the GUI may comprise: providing the GUI in response to successfully logging into an authentication system of the GUI; and generating, based on a role that has been determined by the authentication system based on the successfully logging into the authentication system, the first set of GUI-generated objects.

In the method, the performing of the at least one from among the first set of push operations and the first set of pull operations may comprise: generating at least one first electronic transmission structure by appending, to a first electronic transmission that comprises a first header and a first payload, at least one from among a first identifier of the first partition, a first indication of a first storage location of the first partition, and a first identification of a first schema for the first storage location; transmitting, to the at least one respectively corresponding event broker database, a first set of electronic transmissions that comprises the at least one first electronic transmission structure; and receiving, from the at least one respectively corresponding event broker database, a first set of electronic responses to the first set of electronic transmissions. At least one from among the first set of electronic transmissions and the first set of electronic responses may comprise a first set of event logs.

In the method, the generating of the at least one first electronic transmission structure may comprise: receiving, via the first set of interactions, a first set of inputs that comprises the first identification of the first schema; and utilizing a first template of the first schema to generate, from the first set of event logs, the first header and the first payload. The first set of electronic transmissions comprises the first set of event logs.

In the method, the first template may comprise a new schema that may be built from scratch when the at least one respectively corresponding event broker database does not include the first set of event logs, and the first template may comprise an existing schema that may be built from the first set of event logs when the at least one respectively corresponding event broker database includes the first set of event logs.

In the method, the receiving of the first set of inputs that comprises at least one from among the first identifier and the first indication, may include receiving a selection of the at least one from among the first identifier and the first indication from a first drop-down menu that provides a list of a set of distinct event broker database storage locations that comprises the at least one from among the first identifier and the first indication. The first set of GUI-generated objects may comprise the first drop-down menu.

In the method: the first set of interactions may include receiving a second set of inputs that comprises at least one from among the first identifier, the first indication, and the first identification; and the modifying of the first set of GUI-generated objects may comprise modifying the first set of GUI-generated objects to display the first set of event logs and to indicate that the first set of event logs have been stored, at the at least one from among the first partition and the first storage location of the first partition, according to the first schema.

In the method, the first set of electronic responses may comprise the first set of event logs, the display by the first set of GUI-generated objects of the first set of event logs may comprise utilizing a schema registry of the at least one respectively corresponding event broker database to verify that the first schema has been associated with the first storage location, and the schema registry may associate schema identifications with respectively corresponding sets of storage locations of the at least one respectively corresponding event broker database.

In the method, the receiving of the first set of inputs that comprises the first identification, may include receiving a selection of the first identification from a second drop-down menu that provides a list of a set of distinct schema identifications that comprises the first identification. The first set of GUI-generated objects may comprise the second drop-down menu.

In the method, the utilizing of the first template of the first schema to generate the first header and the first payload may comprise at least one from among: utilizing a large language model (LLM) artificial intelligence and machine learning (AI/ML) algorithm to generate the first template; and utilizing the LLM AI/ML algorithm to generate the first header and the first payload according to the first schema.

In the method, the LLM AI/ML algorithm may have been configured to build schema templates that serve as bases for generating, according to respectively corresponding schemas, electronic data structures that comprise respectively corresponding headers and payloads.

According to another aspect of the present disclosure, a system is provided that implements an event mesh network application emulation tool. The system comprises a processor and memory that stores instructions that, when executed by the processor, cause the processor to perform operations that may comprise: providing a GUI that comprises a first set of GUI-generated objects that comprises at least one GUI-generated object that functionally and contextually correlates to at least one respectively corresponding event broker database of an event mesh network; based on a first set of interactions with the first set of GUI-generated objects, performing, on the at least one respectively corresponding event broker database, at least one from among a first set of push operations and a first set of pull operations; and modifying the first set of GUI-generated objects to reflect a result of the at least one from among the first set of push operations and the first set of pull operations. The at least one respectively corresponding event broker database may comprise a first partition.

In the system, when executed by the processor, the instructions may cause the providing of the GUI to comprise: providing the GUI in response to successfully logging into an authentication system of the GUI; and generating, based on a role that has been determined by the authentication system based on the successfully logging into the authentication system, the first set of GUI-generated objects.

In the system, when executed by the processor, the instructions may cause the performing of the at least one from among the first set of push operations and the first set of pull operations to comprise: generating at least one first electronic transmission structure by appending, to a first electronic transmission that comprises a first header and a first payload, at least one from among a first identifier of the first partition, a first indication of a first storage location of the first partition, and a first identification of a first schema for the first storage location; transmitting, to the at least one respectively corresponding event broker database, a first set of electronic transmissions that comprises the at least one first electronic transmission structure; and receiving, from the at least one respectively corresponding event broker database, a first set of electronic responses to the first set of electronic transmissions. At least one from among the first set of electronic transmissions and the first set of electronic responses may comprise a first set of event logs.

In the system, when executed by the processor, the instructions may cause the generating of the at least one first electronic transmission structure to comprise: receiving, via the first set of interactions, a first set of inputs that comprises the first identification of the first schema; and utilizing a first template of the first schema to generate, from the first set of event logs, the first header and the first payload. The first set of electronic transmissions may comprise the first set of event logs.

In the system, when executed by the processor, the instructions may: cause the first template to comprise a new schema that may be built from scratch when the at least one respectively corresponding event broker database does not include the first set of event logs; and cause the first template to comprise an existing schema that may be built from the first set of event logs when the at least one respectively corresponding event broker database includes the first set of event logs.

In the system, when executed by the processor, the instructions may cause the receiving of the first set of inputs that comprises at least one from among the first identifier and the first indication, to include: receiving a selection of the at least one from among the first identifier and the first indication from a first drop-down menu that provides a list of a set of distinct event broker database storage locations that comprises the at least one from among the first identifier and the first indication. The first set of GUI-generated objects may comprise the first drop-down menu.

In the system, when executed, the instructions may cause the processor to perform further operations. In the further operations: the first set of interactions may include receiving a second set of inputs that comprises at least one from among the first identifier, the first indication, and the first identification; and the modifying of the first set of GUI-generated objects may comprise modifying the first set of GUI-generated objects to display the first set of event logs and to indicate that the first set of event logs have been stored, at the at least one from among the first partition and the first storage location of the first partition, according to the first schema.

In the system, wherein when executed, the instructions may cause the processor to perform further operations. In the further operations, the first set of electronic responses may comprise the first set of event logs, the display by the first set of GUI-generated objects of the first set of event logs may comprise utilizing a schema registry of the at least one respectively corresponding event broker database to verify that the first schema has been associated with the first storage location, and the schema registry may associate schema identifications with respectively corresponding sets of storage locations of the at least one respectively corresponding event broker database.

In the system, when executed by the processor, the instructions may cause the receiving of the first set of inputs that comprises the first identification, to include receiving a selection of the first identification from a second drop-down menu that provides a list of a set of distinct schema identifications that comprises the first identification. The first set of GUI-generated objects may comprise the second drop-down menu.

In the system, when executed by the processor, the instructions may cause the utilizing of the first template of the first schema to generate the first header and the first payload to comprise at least one from among: utilizing an LLM AI/ML algorithm to generate the first template; and utilizing the LLM AI/ML algorithm to generate the first header and the first payload according to the first schema.

In the system, the LLM AI/ML algorithm may have been configured to build schema templates that serve as bases for generating, according to respectively corresponding schemas, electronic data structures that comprise respectively corresponding headers and payloads.

According to yet another aspect of the present disclosure, a non-transitory computer-readable medium is provided for implementing an event mesh network application emulation tool. The computer-readable medium may store instructions that, when executed by a processor, cause the processor to perform operations that comprise: providing a graphical user interface (GUI) that comprises a first set of GUI-generated objects that comprises at least one GUI-generated object that functionally and contextually correlates to at least one respectively corresponding event broker database of an event mesh network; based on a first set of interactions with the first set of GUI-generated objects, performing, on the at least one respectively corresponding event broker database, at least one from among a first set of push operations and a first set of pull operations; and modifying the first set of GUI-generated objects to reflect a result of the at least one from among the first set of push operations and the first set of pull operations. The at least one respectively corresponding event broker database may comprise a first partition.

In the computer-readable medium, when executed by the processor, the instructions may cause the providing of the GUI to comprise: providing the GUI in response to successfully logging into an authentication system of the GUI; and generating, based on a role that has been determined by the authentication system based on the successfully logging into the authentication system, the first set of GUI-generated objects.

In the computer-readable medium, when executed by the processor, the instructions may cause the performing of the at least one from among the first set of push operations and the first set of pull operations to comprise: generating at least one first electronic transmission structure by appending, to a first electronic transmission that comprises a first header and a first payload, at least one from among a first identifier of the first partition, a first indication of a first storage location of the first partition, and a first identification of a first schema for the first storage location; transmitting, to the at least one respectively corresponding event broker database, a first set of electronic transmissions that comprises the at least one first electronic transmission structure; and receiving, from the at least one respectively corresponding event broker database, a first set of electronic responses to the first set of electronic transmissions. At least one from among the first set of electronic transmissions and the first set of electronic responses may comprise a first set of event logs.

In the computer-readable medium, when executed by the processor, the instructions may cause the generating of the at least one first electronic transmission structure to comprise: receiving, via the first set of interactions, a first set of inputs that comprises the first identification of the first schema; and utilizing a first template of the first schema to generate, from the first set of event logs, the first header and the first payload. The first set of electronic transmissions may comprise the first set of event logs.

In the computer-readable medium, when executed by the processor, the instructions may: cause the first template to comprise a new schema that may be built from scratch when the at least one respectively corresponding event broker database does not include the first set of event logs; and cause the first template to comprise an existing schema that may be built from the first set of event logs when the at least one respectively corresponding event broker database includes the first set of event logs.

In the computer-readable medium, when executed by the processor, the instructions may cause the receiving of the first set of inputs that comprises at least one from among the first identifier and the first indication, to include receiving a selection of the at least one from among the first identifier and the first indication from a first drop-down menu that provides a list of a set of distinct event broker database storage locations that comprises the at least one from among the first identifier and the first indication. The first set of GUI-generated objects may comprise the first drop-down menu.

In the computer-readable medium, when executed, the instructions may cause the processor to perform further operations. In the further operations: the first set of interactions may include receiving a second set of inputs that comprises at least one from among the first identifier, the first indication, and the first identification; and the modifying of the first set of GUI-generated objects may comprise modifying the first set of GUI-generated objects to display the first set of event logs and to indicate that the first set of event logs have been stored, at the at least one from among the first partition and the first storage location of the first partition, according to the first schema.

In the computer-readable medium, when executed, the instructions may cause the processor to perform further operations. In the further operations, the first set of electronic responses may comprise the first set of event logs, the display by the first set of GUI-generated objects of the first set of event logs may comprise utilizing a schema registry of the at least one respectively corresponding event broker database to verify that the first schema has been associated with the first storage location, and the schema registry may associate schema identifications with respectively corresponding sets of storage locations of the at least one respectively corresponding event broker database.

In the computer-readable medium, when executed by the processor, the instructions may cause the receiving of the first set of inputs that comprises the first identification, to include receiving a selection of the first identification from a second drop-down menu that provides a list of a set of distinct schema identifications that comprises the first identification. The first set of GUI-generated objects may comprise the second drop-down menu.

In the computer-readable medium, when executed by the processor, the instructions may cause the utilizing of the first template of the first schema to generate the first header and the first payload to comprise at least one from among: utilizing an LLM AI/ML algorithm to generate the first template; and utilizing the LLM AI/ML algorithm to generate the first header and the first payload according to the first schema.

In the computer-readable medium, the LLM AI/ML algorithm may have been configured to build schema templates that serve as bases for generating, according to respectively corresponding schemas, electronic data structures that comprise respectively corresponding headers and payloads.

Accordingly, the invention disclosed herein provides a tool that emulates event mesh network applications.

### BRIEF DESCRIPTION OF THE DRAWINGS

The present disclosure is further described in the detailed description which follows, in reference to the noted plurality of drawings, by way of non-limiting examples of the present disclosure, in which like characters represent like elements throughout the several views of the drawings.

FIG. 1 depicts a diagram of computer system, according to an embodiment.

FIG. 2 depicts a diagram of an environment for implementing an event mesh network application emulation tool, according to an embodiment.

FIG. 3 depicts a diagram of an aspect of an environment that is configured to implement an event mesh network application emulation tool, according to an embodiment.

FIG. 4 depicts a flowchart of a process for implementing an event mesh network application emulation tool, according to an embodiment.

FIG. 5 depicts a diagram of an implementation of an event mesh network application emulation tool, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out operations necessary to implement the methods of the examples of this technology that are described and illustrated herein.

As described in further detail below, the herein-disclosed technology implements an event mesh network application emulation tool.

Accordingly, by employing the herein-disclosed technique within one or more event mesh networks, the technique disclosed herein provides a technical improvement to event mesh network application development and debugging.

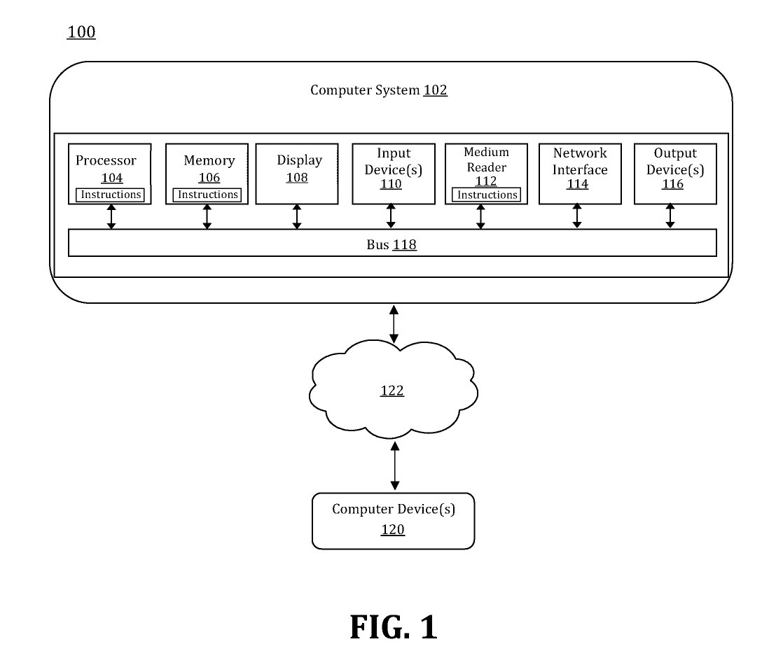

FIG. 1 is a system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for longer than a transitory period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely examples and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described in further detail below, the various embodiments disclosed herein provide methods, systems and computer-readable media for implementing an event mesh network application emulation tool.

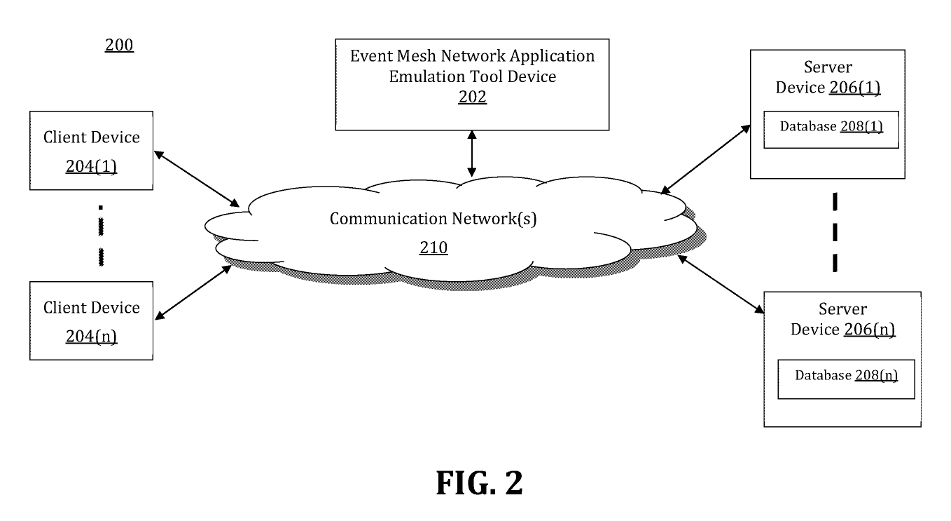

Referring to FIG. 2, a schematic of a network environment 200 for implementing an event mesh network application emulation tool. In an embodiment, the event mesh network application emulation tool may be implemented on any networked computer platform, such as, for example, a personal computer (PC).

A method of emulating event mesh network applications, may be implemented by an event mesh network application emulation tool (EMNAET) device 202. The EMNAET device 202 may be the same or similar to the computer system 102 as described with respect to FIG. 1. The EMNAET device 202 may be a rack-mounted server in a datacenter, an embedded microcontroller (MCU) in an electronic device, or another type of headless system, which is a computer system or device that is configured to operate without a monitor, keyboard and mouse. The EMNAET device 202 may store one or more applications that can include executable instructions that, when executed by the EMNAET device 202, cause the EMNAET device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the EMNAET device 202 itself, may be located in virtual server(s) running in a cloud-based computing environment rather than being tied to one or more specific physical network computing devices. Also, the application(s) may be running in one or more virtual machines (VMs) executing on the EMNAET device 202. Additionally, in one or more embodiments of this technology, virtual machine(s) running on the EMNAET device 202 may be managed or supervised by a hypervisor.

In the network environment 200 of FIG. 2, the EMNAET device 202 is coupled to a plurality of client devices 204(1)-204(n), and also to a plurality of server devices 206(1)-206(n) that hosts a plurality of databases 208(1)-208(n) via communication network(s) 210. A communication interface of the EMNAET device 202, such as the network interface 114 of the computer system 102 of FIG. 1, operatively couples and communicates between the EMNAET device 202, the client devices 204(1)-204(n), and/or the server devices 206(1)-206(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the EMNAET device 202, the client devices 204(1)-204(n), and/or the server devices 206(1)-206(n) may be coupled together via other topologies. Additionally, the network environment 200 may include other network devices such as one or more routers and/or switches, for example, which are well known in the art and thus will not be described herein. This technology provides a number of advantages including methods, computer readable media, and EMNAET devices that implement a method for an event mesh network application emulation tool that emulates event mesh network applications.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. For the purposes of the present disclosure, it should be noted that: the term “remote” may refer to a “physical” and/or “virtual” remoteness; and the term “local” may refer to a “physical” and/or “virtual” locale.

The EMNAET device 202 may be a standalone device or integrated with one or more other devices or apparatuses, such as one or more of the server devices 206(1)-206(n), for example. In one particular example, the EMNAET device 202 may include or be hosted by one of the server devices 206(1)-206(n), and other arrangements are also possible. As another example, the EMNAET device 202 may be integrated with one or more other devices or apparatuses, such as one or more of the client devices 204(1)-204(n). Moreover, one or more of the devices of the EMNAET device 202 may be in a same or a different communication network including one or more public, private, or cloud networks, for example.

The plurality of server devices 206(1)-206(n) may be the same or similar to the computer system 102 or the computer device 120 as described with respect to FIG. 1, including any features or combination of features described with respect thereto. For example, any of the server devices 206(1)-206(n) may include, among other features, one or more processors, memories and communication interfaces, which are coupled together by at least one bus or other communication link, although other numbers and/or types of network devices may be used. The server devices 206(1)-206(n) in this example may process requests received from the EMNAET device 202 via the communication network(s) 210 according to an HTTP-based and/or JavaScript Object Notation (JSON) protocol, for example, although other protocols may also be used.

The server devices 206(1)-206(n) may be hardware or software or may represent a system with multiple servers in a pool, which may include internal or external networks. The server devices 206(1)-206(n) hosts the databases 208(1)-208(n) that are configured to store data.

Although the server devices 206(1)-206(n) are illustrated as single devices, one or more actions of each of the server devices 206(1)-206(n) may be distributed across one or more distinct network computing devices that together comprise one or more of the server devices 206(1)-206(n). Moreover, the server devices 206(1)-206(n) are not limited to a particular configuration. Thus, the server devices 206(1)-206(n) may contain a plurality of network computing devices that operate using a master/slave approach, whereby one of the network computing devices of the server devices 206(1)-206(n) operates to manage and/or otherwise coordinate operations of the other network computing devices.

The server devices 206(1)-206(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures are also envisaged.

The plurality of client devices 204(1)-204(n) may also be the same or similar to the computer system 102 or the computer device 120 as described with respect to FIG. 1, including any features or combination of features described with respect thereto. For example, the client devices 204(1)-204(n) in this example may include any type of computing device that can interact with the EMNAET device 202 via communication network(s) 210. Accordingly, the client devices 204(1)-204(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 204 is a wireless mobile communication device, i.e., a smart phone.

The client devices 204(1)-204(n) may run interface applications, such as standard web browsers or standalone client applications, which may provide an interface to communicate with the EMNAET device 202 via the communication network(s) 210 in order to communicate user requests and other information. The client devices 204(1)-204(n) may further include, among other features, a display device, such as a display screen or touchscreen, and/or an input device, such as a keyboard, for example. The client devices 204(1)-204(n) may host one or more applications that are proprietary to an enterprise that may be secured against eavesdropping, and these applications may be distributed among client devices 204(1)-204(n). The enterprise’s distributed applications may include software that is based on microservices architecture, for example.

Although the network environment 200 with the EMNAET device 202, the client devices 204(1)-204(n), the server devices 206(1)-206(n), the databases 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the EMNAET device 202, the client devices 204(1)-204(n), the server devices 206(1)-206(n), and the databases 208(1)-208(n), for example, may be configured to operate as virtual instances on the same physical machine. In other words, one or more of the EMNAET device 202, the server devices 206(1)-206(n), the client devices 204(1)-204(n), and the databases 208(1)-208(n) may operate on a common physical device rather than as separate devices communicating through communication network(s) 210. Additionally, there may be more or fewer client devices 204(1)-204(n), server devices 206(1)-206(n), and databases 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

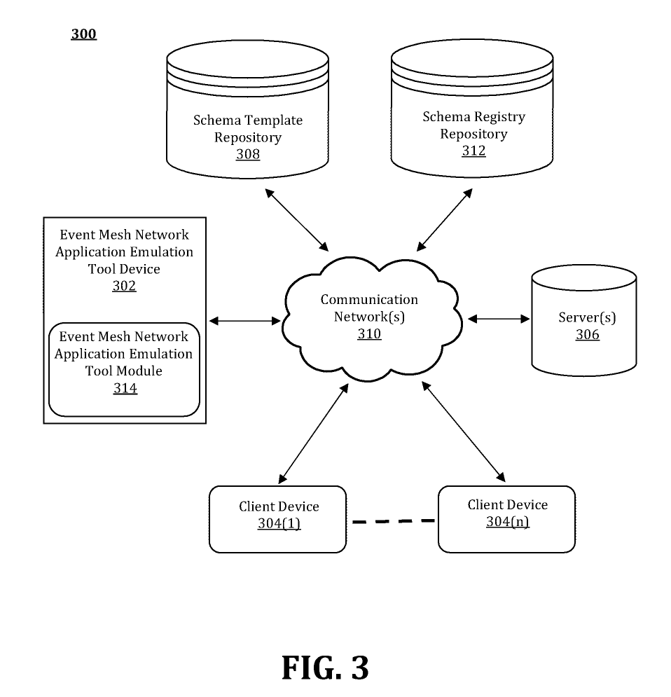

The EMNAET device 302 is described and illustrated in FIG. 3 as including event mesh network application emulation tool module 314, although it may include other rules, policies, modules, databases, or applications, for example. As will be described below, event mesh network application emulation tool module 314 is configured to implement event mesh network application emulation within at least one event mesh network, such as communication network(s) 310, for example. Event mesh network application emulation tool module 314 may include software that is based on microservices architecture, for example.

Event mesh network application emulation tool module 314 may be integrated with one or more devices or apparatuses, such as client devices 304(1)-304(n), where event mesh network application emulation tool module 314 may be implemented as an application or as an addon or plugin to another application of the one or more devices or apparatuses, and where event mesh network application emulation tool module 314 may execute in the background.

A configuration 300 for implement an event mesh network application emulation tool within an aspect of the network environment of FIG. 2 is illustrated as being executed in FIG. 3. Specifically, client devices 304(1)-304(n) are illustrated as being in communication with EMNAET device 302. In this regard, a first client device 304(1) and at least a second client device 304(2) may be “clients” of the EMNAET device 302 and are described herein as such. Nevertheless, it is to be known and understood that client device 304(1) and/or at least client device 304(2) need not necessarily be “clients” of the EMNAET device 302, or any entity described in association therewith herein. Any additional or alternative relationship may exist between client device 304(1), client device 304(2) and EMNAET device 302.

Event mesh network application emulation tool module 314 of EMNAET device 302 may communicate with at least one database and/or repository, such as schema template repository 308. Thereby, as described in further detail below, EMNAET device 302 may obtain at least one schema template from schema template repository 308 and utilize the at least one template to push at least one event log to an event mesh network broker database, which may correspond to a database such as database(s) 208(x) (and server 208(x) may correspond to an event mesh network broker of the event mesh network broker database).

In addition, event mesh network application emulation tool module 314 of EMNAET device 302 may communicate with schema registry repository 312. Thereby, as described in further detail below, EMNAET device 302 may utilize schema registry repository 312 to pull a set of event logs from the event mesh network database.

In an embodiment, event mesh network application emulation tool module 314 may be configured to provide a dynamically customizable interface for selecting, to communicate with, at least one server device at least one from among server devices 306(1)-306(n). Moreover, EMNAET device 302 may receive and transmit data via communication network(s) 210. EMNAET device 302 may receive and transmit data such as code that is written in one or more of the following dialects: transaction control language (TCL), data manipulation language (DML), data control language (DCL) and data definition language (DDL). Additionally, via communication network(s) 310, EMNAET device 302 may respectively receive and transmit data from and to one or more from among client devices 304(1)-304(n) and the server devices 306(1)-306(n).

However, FIG. 3 depicts client device 304(1) and at least client device 304(n) as belonging to communication network(s) 310, and EMNAET device 302 may communicate with any one or more devices or apparatuses that belong to the communication network(s) 310, such as one or more from among client devices 304(1)-304(n). For example, EMNAET device 302 may utilize a graphical user interface (GUI) to communicate with one or more from among client devices 304(1)-304(n), and communication network(s) 310 may comprise a cluster that belongs to the above-mentioned enterprise that may be secured against eavesdropping. In a further embodiment, communication network(s) 310 may comprise a cluster of distributed applications that belong to the enterprise.

Client device 304(1) may be, for example, a smart phone. Of course, client device 304(1) may be any additional device described herein. Client device 304(n) may be, for example, a personal computer (PC). Of course, client device 304(n) may also be any additional device described herein.

The client devices 304(1)-304(n) may represent, for example, computer systems of the enterprise’s client network. Client device 304(1) may represent, for example, one or more computer systems of a client or of a cluster of clients within the enterprise or client network. Of course, client device 304(1) may include one or more of any of the devices described herein. Client device 304(n) may be, for example, one or more computer systems of another client or cluster of clients within the enterprise or client network. Of course, client device 304(n) may include one or more of any of the devices described herein.

The herein-disclosed process(es) may be executed via the communication network(s) 310, which may comprise a plurality of networks, as described above. For example, in an embodiment, either or both of client device 304(1) and client device 204(n) may communicate with the EMNAET device 302 via broadband or cellular communication. Of course, these embodiments are merely exemplary and are not limiting or exhaustive.

Event mesh network application emulation tool module 314 may programmatically configure and communicate with client devices 304(1)-304(n), which may respectively correspond to one or more remote clusters of endpoints, for example.

Event mesh network application emulation tool module 314 may execute a process that programmatically configures and communicates with one or more client devices from among client devices 304(1)-304(n). In embodiments, at least one from among server devices 306(1)-306(n) may comprise large language model (LLM) architecture that provides artificial intelligence and machine learning (AI/ML) services within communication network(s) 310.

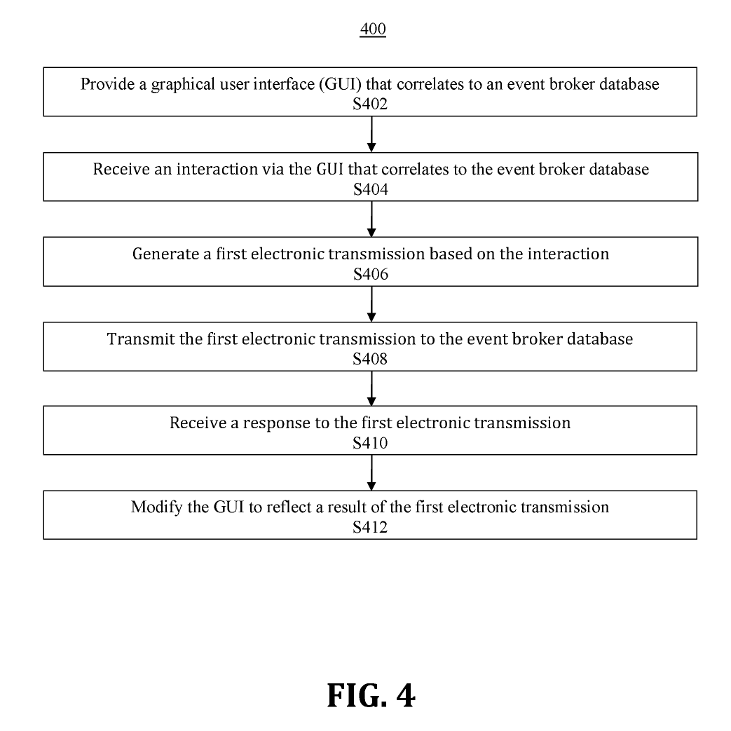

A process for implementing an event mesh network application emulation tool is generally indicated in FIG. 4 at flowchart 400. Process 400 may be implemented by an event mesh network application emulation tool, such as event mesh network application emulation tool 202, event mesh network application emulation tool device 302 and/or event mesh network application emulation tool module 314.

Process 400 may begin at step S402, where the event mesh network application emulation tool may provide a GUI that comprises a first set of GUI-generated objects that comprises at least one GUI-generated object that functionally and contextually correlates to at least one respectively corresponding event broker database of an event mesh network. The at least one respectively corresponding event broker database may comprise a first partition.

In some embodiments, step S402 may being by utilizing the GUI to provide a login request to at least one from among a user and a client via a client device such as client devices 304(1)-304(n). In response to the login request, at least one from among a user identity of the user and a client identity of the client, may be authenticated (via the GUI) with an authentication system of the event mesh network application emulation tool.

Thereby, upon successfully authenticating with the authentication system, the event mesh network application emulation tool may utilize the at least one from among the user identity and the client identity, to determine a role that has been assigned to the at least one from among the user and the client.

Thereafter, the event mesh network application emulation tool may utilize the role to generate the first set of GUI-generated objects (1) by having the first set of GUI-generated objects only include GUI-generated objects that have been authorized for the role and (2) by having the first set of GUI-generated objects exclude any GUI-generated objects that have not been authorized for the role.

At step S404, the event mesh network application emulation tool may receive a first set of interactions via the first set of GUI-generated objects. The first set of interactions may be performed, with the first set of GUI-generated objects, by the user and/or client via the client device (e.g., client devices 304(1)-304(n)).

At step S406, the event mesh network application emulation tool may utilize the first set of interactions to generate at least one first electronic transmission structure, and the at least one first electronic transmission structure may be generated by appending, to a first electronic transmission that comprises a first header and a first payload, at least one from among a first identifier of the first partition, a first indication of a first storage location of the first partition, and a first identification of a first schema for the first storage location.

At step S408, the event mesh network application emulation tool may transmit, to the at least one respectively corresponding event broker database, a first set of electronic transmissions that comprises the at least one first electronic transmission structure.

At step S410, the event mesh network application emulation tool may receive, from the at least one respectively corresponding event broker database, a first set of electronic responses to the first set of electronic transmissions. At least one from among the first set of electronic transmissions and the first set of electronic responses, may comprise a first set of event logs.

In some embodiments, the generation of the at least one first electronic transmission structure may comprise: (1) receiving, via the first set of interactions, a first set of inputs that comprises the first identification of the first schema; and (2) utilizing a first template of the first schema to generate, from the first set of event logs, the first header and the first payload, wherein the first set of electronic transmissions comprises the first set of event logs.

In such embodiments, the receipt of the first set of inputs that comprises the first identification may include receiving a selection of the first identification from a first drop-down menu that provides a list of a set of distinct schema identifications that comprises the first identification, and the first set of GUI-generated objects may comprise the first drop-down menu.

Also (and/or alternatively), in such embodiments, the utilization of the first template of the first schema to generate the first header and the first payload may comprise at least one from among: (1) utilizing an LLM AI/ML algorithm to generate the first template; and (2) utilizing the LLM AI/ML algorithm to generate the first header and the first payload according to the first schema. In further embodiments, the LLM AI/ML algorithm may have been configured to build schema templates that serve as bases for generating, according to respectively corresponding schemas, electronic data structures that comprise respectively corresponding headers and payloads.

In embodiments, when the at least one respectively corresponding event broker database does not include the first set of event logs, the first template may comprise a new schema that may be built from scratch and, then, utilized to populate the at least one respectively corresponding event broker database. According to embodiments, this new schema may primarily be utilized for testing purposes.

Thereafter, when the at least one respectively corresponding event broker database includes the first set of event logs, the first template may comprise an existing schema that may be built from the first set of event logs. According to some embodiments, the LLM AI/ML algorithm may be utilized to build the existing schema by deserializing the first set of event logs obtained from the at least one respectively corresponding event broker database.

At step S412, the event mesh network application emulation tool may modify the first set of GUI-generated objects to reflect a result of the at least one from among the first set of push operations and the first set of pull operations. After step S412, process 400 may end or repeat.

It should be noted that in some embodiments, the first set of interactions may include receiving a second set of inputs that comprise at least one from among the first identifier, the first indication, and the first identification. Additionally, in such embodiments, the modification of the first set of GUI-generated objects may comprise modifying the first set of GUI-generated objects: (1) to display the first set of event logs; and (2) to indicate that the first set of event logs have been stored, at the at least one from among the first partition and the first storage location of the first partition, according to the first schema.

It should also be noted that in further embodiments, the first set of electronic responses may comprise the first set of event logs, the display (by the first set of GUI-generated objects) of the first set of event logs may comprise utilizing a schema registry of the at least one respectively corresponding event broker database to verify that the first schema has been associated with the first storage location, and the schema registry may associate schema identifications with respectively corresponding sets of storage locations of the at least one respectively corresponding event broker database.

Also (and/or alternatively), in the further embodiments, the receipt of the first set of inputs that comprises at least one from among the first identifier and the first indication, may include receiving a selection of the at least one from among the first identifier and the first indication from a second drop-down menu that provides a list of a set of distinct event broker database storage locations that comprises the at least one from among the first identifier and the first indication. Additionally, in such embodiments, the first set of GUI-generated objects may comprise the second drop-down menu.

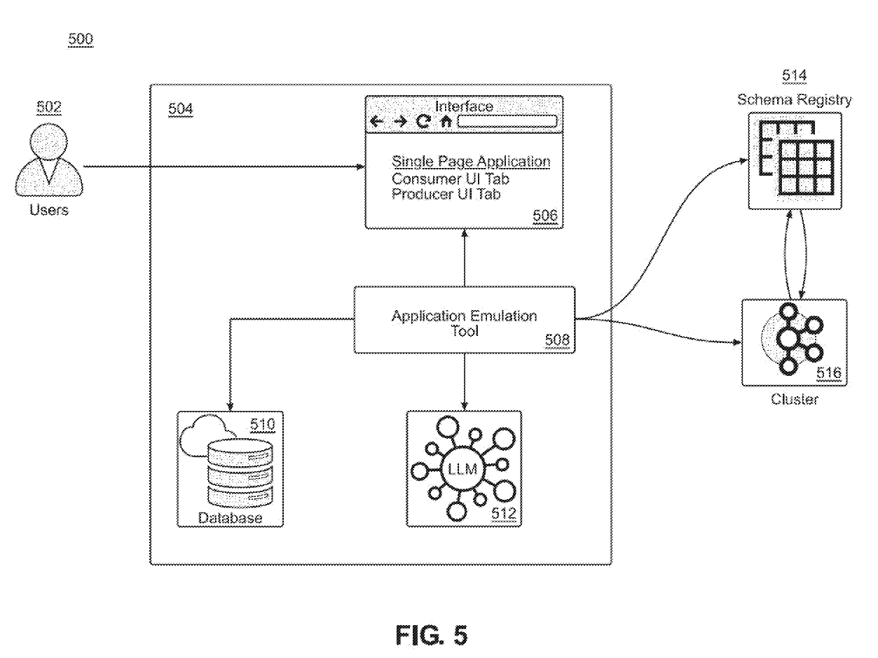

An implementation of an event mesh network application emulation tool is generally illustrated in FIG. 5. More particularly, FIG. 5 depicts an environment 500 in which a user 502 may utilize event mesh network application emulation tool 504 to access cluster 516 of an event mesh network. For the purposes of this disclosure, although depicted as an induvial, user 502 may also (or alternatively) represent a client device and/or software application, such as client device 204/304. In addition, cluster 516 may comprise a set of event brokers databases/devices, such as server devices 206(1)-206(n), for example.

Accordingly, user 502 may utilize event mesh network application emulation tool 504 by interacting with interface 506. In an embodiment, interface 506 may include a GUI (and/or an API) that comprises a set of GUI-generated objects, which includes: (1) a first option that provides (via interface 506) user 502 with a first set of additional GUI-generated objects that trigger functionalities of an event mesh network consumer application; and (2) a second option that provides (via interface 506) user 502 with a second set of additional GUI-generated objects that trigger functionalities of an event mesh network producer application.

According to the approach disclosed herein, application emulation tool 508 may be configured to receive (or obtain) the interaction between user 502 and interface 506, then application emulation tool 508 may utilize the interaction to emulate at least one from among the event mesh network consumer application and the event mesh network producer application, by at least one from among: (1) pulling at least one event log from the event broker of cluster 516; and (2) pushing at least one event log to an event broker of cluster 516, respectively.

Hence, in response to interactions between user 502 and interface 508, application emulation tool 508 may utilize database 510 and/or LLM 512 to emulate an event mesh network application, e.g., event producer application, an event consumer application, etc. More particularly, application emulation tool 508 may emulate event consumer applications by utilizing a schema registry 514 of cluster 516 to pull event logs from cluster 516, and application emulation tool 508 may emulate event producer applications by utilizing database 510 and/or LLM 512 to push event logs to cluster 516.

For example, interface 506 may generate event producer application control objects, and user 502 may interact with a GUI-generated object that corresponds to a first electronic data structure schema. In response, application emulation tool 508 may utilize database 510 and/or LLM 512 to convert at least one event log according to the first electronic data structure schema.

Application emulation tool 508 may utilize schema template from schema registry 514 to convert at least one event log according to the first electronic data structure schema by: (1) obtaining a template of the first electronic data structure schema from schema registry 514, (2) populating the template with the at least one event log according to the template’s fields, and (3) generating the first electronic data structure based on the populated template. Schema registry 514 may comprise a plurality of templates that have been associated with a plurality of respectively corresponding electronic data structure schemas.

Additionally (and/or alternatively), application emulation tool 508 may utilize LLM 512 to convert at least one event log according to the first electronic data structure schema by querying LLM 512, which may return the first electronic data structure based on the at least one event log and the first electronic data structure schema. LLM 512 may comprise at least one AI/ML algorithm that has been configured to utilize the at least one event log and the first electronic data structure schema, to generate the first electronic data structure.

Subsequently, application emulation tool 508 may emulate an event producer application by transmitting the first electronic data structure to cluster 516.

Interface 506 may also (or alternatively) generate event consumer application control objects, and user 502 may interact with a GUI-generated object that corresponds to a first partition (and, optionally, indicates a first location of the first partition) of at least one event broker database from among cluster 516. Additionally (and/or alternatively), user 502 may interact with a GUI-generated object that corresponds to at least an event topic.

In response to the interaction, application emulation tool 508 may utilize at least the first partition (and/or at least the first location of at least the first partition) and/or at least the event topic, to search schema registry 514 for a second electronic data structure schema that has been associated with the first partition (and/or the first location of at least the first partition).

Subsequently, application emulation tool 508 may emulate an event consumer application by pulling a second electronic data structure that has been stored at the first partition (and/or the first location) from at least one event broker of cluster 516 and, thereafter, application emulation tool 508 may utilize the second electronic data structure schema to convert the second electronic data structure into at least one event log.

Thereby, according to the approaches described herein, a tool that emulates an event mesh network application, may be utilized to debug and develop event mesh networks and their applications.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Therefore, applications of the present disclosure are not limited to electronic resource usage efficiency improvements and may be extended to provide a technical improvement to efforts in other technological areas.

Accordingly, although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of implementing an event mesh network application emulation tool, the method comprising:
providing a graphical user interface (GUI) that comprises a first set of GUI-generated objects that comprises at least one GUI-generated object that functionally and contextually correlates to at least one respectively corresponding event broker database of an event mesh network, wherein the at least one respectively corresponding event broker database comprises a first partition;
based on a first set of interactions with the first set of GUI-generated objects, performing, on the at least one respectively corresponding event broker database, at least one from among a first set of push operations and a first set of pull operations; and
modifying the first set of GUI-generated objects to reflect a result of the at least one from among the first set of push operations and the first set of pull operations.

2. The method of claim 1, wherein the providing of the GUI comprises:
providing the GUI in response to successfully logging into an authentication system of the GUI; and
generating, based on a role that has been determined by the authentication system based on the successfully logging into the authentication system, the first set of GUI-generated objects.

3. The method of claim 1, wherein the performing of the at least one from among the first set of push operations and the first set of pull operations comprises:
generating at least one first electronic transmission structure by appending, to a first electronic transmission that comprises a first header and a first payload, at least one from among a first identifier of the first partition, a first indication of a first storage location of the first partition, and a first identification of a first schema for the first storage location;
transmitting, to the at least one respectively corresponding event broker database, a first set of electronic transmissions that comprises the at least one first electronic transmission structure; and
receiving, from the at least one respectively corresponding event broker database, a first set of electronic responses to the first set of electronic transmissions, wherein at least one from among the first set of electronic transmissions and the first set of electronic responses comprises a first set of event logs.

4. The method of claim 3, wherein the generating of the at least one first electronic transmission structure comprises:
receiving, via the first set of interactions, a first set of inputs that comprises the first identification of the first schema; and
utilizing a first template of the first schema to generate, from the first set of event logs, the first header and the first payload, wherein the first set of electronic transmissions comprises the first set of event logs.

5. The method of claim 4, wherein the first template comprises a new schema that is built from scratch when the at least one respectively corresponding event broker database does not include the first set of event logs, and wherein the first template comprises an existing schema that is built from the first set of event logs when the at least one respectively corresponding event broker database includes the first set of event logs.

6. The method of claim 4, wherein the receiving of the first set of inputs that comprises at least one from among the first identifier and the first indication, includes:
receiving a selection of the at least one from among the first identifier and the first indication from a first drop-down menu that provides a list of a set of distinct event broker database storage locations that comprises the at least one from among the first identifier and the first indication, wherein the first set of GUI-generated objects comprises the first drop-down menu.

7. The method of claim 4:
wherein the first set of interactions includes receiving a second set of inputs that comprises at least one from among the first identifier, the first indication, and the first identification; and
wherein the modifying of the first set of GUI-generated objects comprises modifying the first set of GUI-generated objects to display the first set of event logs and to indicate that the first set of event logs have been stored, at the at least one from among the first partition and the first storage location of the first partition, according to the first schema.

8. The method of claim 7:
wherein the first set of electronic responses comprises the first set of event logs;
wherein the display, by the first set of GUI-generated objects, of the first set of event logs comprises utilizing a schema registry of the at least one respectively corresponding event broker database to verify that the first schema has been associated with the first storage location; and
wherein the schema registry associates schema identifications with respectively corresponding sets of storage locations of the at least one respectively corresponding event broker database.

9. The method of claim 8, wherein the receiving of the first set of inputs that comprises the first identification, includes:
receiving a selection of the first identification from a second drop-down menu that provides a list of a set of distinct schema identifications that comprises the first identification, wherein the first set of GUI-generated objects comprises the second drop-down menu.

10. The method of claim 8, wherein the utilizing of the first template of the first schema to generate the first header and the first payload comprises at least one from among:
utilizing a large language model (LLM) artificial intelligence and machine learning (AI/ML) algorithm to generate the first template; and
utilizing the LLM AI/ML algorithm to generate the first header and the first payload according to the first schema.

11. The method of claim 10, wherein the LLM AI/ML algorithm has been configured to:
build schema templates that serve as bases for generating, according to respectively corresponding schemas, electronic data structures that comprise respectively corresponding headers and payloads.

12. A system of implementing an event mesh network application emulation tool, the system comprising:
a processor; and
memory storing instructions that, when executed by the processor, cause the processor to perform operations that comprise:
providing a graphical user interface (GUI) that comprises a first set of GUI-generated objects that comprises at least one GUI-generated object that functionally and contextually correlates to at least one respectively corresponding event broker database of an event mesh network, wherein the at least one respectively corresponding event broker database comprises a first partition;
based on a first set of interactions with the first set of GUI-generated objects, performing, on the at least one respectively corresponding event broker database, at least one from among a first set of push operations and a first set of pull operations; and
modifying the first set of GUI-generated objects to reflect a result of the at least one from among the first set of push operations and the first set of pull operations.

13. The system of claim 12, wherein when executed by the processor, the instructions cause the performing of the at least one from among the first set of push operations and the first set of pull operations to comprise:
generating at least one first electronic transmission structure by appending, to a first electronic transmission that comprises a first header and a first payload, at least one from among a first identifier of the first partition, a first indication of a first storage location of the first partition, and a first identification of a first schema for the first storage location;
transmitting, to the at least one respectively corresponding event broker database, a first set of electronic transmissions that comprises the at least one first electronic transmission structure; and
receiving, from the at least one respectively corresponding event broker database, a first set of electronic responses to the first set of electronic transmissions, wherein at least one from among the first set of electronic transmissions and the first set of electronic responses comprises a first set of event logs.

14. The system of claim 13, wherein when executed by the processor, the instructions cause the generating of the at least one first electronic transmission structure to comprise:
receiving, via the first set of interactions, a first set of inputs that comprises the first identification of the first schema; and
utilizing a first template of the first schema to generate, from the first set of event logs, the first header and the first payload, wherein the first set of electronic transmissions comprises the first set of event logs.

15. The system of claim 14, wherein when executed by the processor, the instructions cause the receiving of the first set of inputs that comprises at least one from among the first identifier and the first indication, to include:
receiving a selection of the at least one from among the first identifier and the first indication from a first drop-down menu that provides a list of a set of distinct event broker database storage locations that comprises the at least one from among the first identifier and the first indication, wherein the first set of GUI-generated objects comprises the first drop-down menu.

16. A non-transitory computer-readable medium for implementing an event mesh network application emulation tool, the computer-readable medium storing instructions that, when executed by a processor, cause the processor to perform operations that comprise:
providing a graphical user interface (GUI) that comprises a first set of GUI-generated objects that comprises at least one GUI-generated object that functionally and contextually correlates to at least one respectively corresponding event broker database of an event mesh network, wherein the at least one respectively corresponding event broker database comprises a first partition;
based on a first set of interactions with the first set of GUI-generated objects, performing, on the at least one respectively corresponding event broker database, at least one from among a first set of push operations and a first set of pull operations; and
modifying the first set of GUI-generated objects to reflect a result of the at least one from among the first set of push operations and the first set of pull operations.

17. The computer-readable medium of claim 16, wherein when executed by the processor, the instructions cause the performing of the at least one from among the first set of push operations and the first set of pull operations to comprise:
generating at least one first electronic transmission structure by appending, to a first electronic transmission that comprises a first header and a first payload, at least one from among a first identifier of the first partition, a first indication of a first storage location of the first partition, and a first identification of a first schema for the first storage location;
transmitting, to the at least one respectively corresponding event broker database, a first set of electronic transmissions that comprises the at least one first electronic transmission structure; and
receiving, from the at least one respectively corresponding event broker database, a first set of electronic responses to the first set of electronic transmissions, wherein at least one from among the first set of electronic transmissions and the first set of electronic responses comprises a first set of event logs.

18. The computer-readable medium of claim 17, wherein when executed by the processor, the instructions cause the generating of the at least one first electronic transmission structure to comprise:
receiving, via the first set of interactions, a first set of inputs that comprises the first identification of the first schema; and
utilizing a first template of the first schema to generate, from the first set of event logs, the first header and the first payload, wherein the first set of electronic transmissions comprises the first set of event logs.

19. The computer-readable medium of claim 18, wherein when executed by the processor, the instructions cause:
the first set of interactions to include receiving a second set of inputs that comprises at least one from among the first identifier, the first indication, and the first identification; and
the modifying of the first set of GUI-generated objects to comprise modifying the first set of GUI-generated objects to display the first set of event logs and to indicate that the first set of event logs have been stored, at the at least one from among the first partition and the first storage location of the first partition, according to the first schema.

20. The computer-readable medium of claim 19, wherein when executed by the processor, the instructions cause:
the first set of electronic responses to comprise the first set of event logs;
the display, by the first set of GUI-generated objects, of the first set of event logs to comprise utilizing a schema registry of the at least one respectively corresponding event broker database to verify that the first schema has been associated with the first storage location; and
the schema registry to associate schema identifications with respectively corresponding sets of storage locations of the at least one respectively corresponding event broker database.
